(19) United States
(12) Patent Application Publication
(10) Pub. No.: US 2008/0137821 A1
(43) Pub. Date: Jun. 12, 2008

(54) Method and apparatus for routing isolated auxiliary signals using coaxial cables

(76) Inventor: Kesse Ho, Westminster, CA (US)

Correspondence Address: Vista IP Law Group LLP, 2040 MAIN STREET, 9TH FLOOR, IRVINE, CA, 92614, US

(21) Appl. No.: 11/823,962

(22) Filed: Jun. 29, 2007

Related U.S. Application Data
(60) Provisional application No. 60/873,811, filed on Dec. 9, 2006.

(51) Int. Cl. H04M 11/00

(52) U.S. Cl. 379/90.01

(57) ABSTRACT

A method and apparatus for routing auxiliary signals, such as telephone land line signals from a telephone jack, to a remotely located electronic device, such as a satellite signal receiver, includes modifying coaxial cables used to connect the remote electronic device to another device such as a satellite antenna or multiple antennas, multi-switch box, by affixing auxiliary signal wires to lengths of coaxial cables. Ends of auxiliary wires at a downstream end of a modified coaxial cable adjacent to a remote electronic device are stripped and connected to a network port of that device, and ends of wires at a downstream end of modified cable closest to a network port such as a telephone jack are stripped and connected to the network port. Upstream ends of auxiliary signal wires at upstream ends of the two cables connected to an intermediate electronic device such as a satellite multi-switch box are stripped and connected together through bridging circuitry consisting of electrical connections to form a phone bridge for telephone network connections, or of electronic interface circuitry for Ethernet or other such networks.

The present application claims priority to U.S. provisional patent application No. 60/873,811, filed on Dec. 9, 2006 by the present inventor, Kesse Ho.

### BACKGROUND OF THE INVENTION

A. Field of the Invention

The present invention relates to devices for the reception and transmission of electrical signals. More particularly, the invention relates to a method and apparatus for conveying auxiliary signals such as telephone or ethernet signals using auxiliary conductors fixed to a coaxial cable, while maintaining electrical isolation between the coaxial cable conductors and auxiliary conductors. Specifically, the invention relates to a bridge method and apparatus for routing signals from a telephone land-line jack, ethernet port or other such network port to a remotely located device such as a satellite receiver box, using a modified coaxial cable.

B. Description of Background Art

There are a large number of residences and businesses which subscribe to satellite or cable television services. Most such services require for channel selection, decoding and the like, a satellite receiver box, typically referred to as an Integrated Receiver Decoder (IRD), which is located close to a television receiver or monitor. A satellite receiver box or IRD has an input port which is connected via a coaxial cable to a satellite dish, or to a coaxial cable which interfaces with an exterior distribution network cable or service provider.

Most cable receiver or IRD boxes of the type described above require that the receiver box apparatus be connected to a user's telephone line. The phone line connection is required so that a service provider can monitor whether the receiver is located legally, and to enable charges to be made for pay-per-view purchases, among other purposes. The required access to a phone line is often problematic, for the following reasons.

In a typical residence and some businesses, a suitable location for a television set, such as a living room, is located a substantial distance away from the nearest telephone jack. In such cases, connection must be made between the receiver box and the telephone jack by running long wires underneath a carpet, along the edge of a wall, or suspended from an overhead run. Such expedients may not only be aesthetically dissatisfying, but may actually be unsafe, such as by posing a tripping hazard. Also, if it is desired to move the receiver box to another location within a residence or business, or to an entirely new geographic location, the problem of making the required connection to a telephone jack reoccurs.

One proposed solution to the problem of not always having a telephone jack close-by to a desired location for a satellite receiver or a cable box utilizes a rather complex and expensive “triplexer” system. The triplexer system includes a multi-switch subsystem which enables remote selection from an IRD or receiver box of one of several satellite dish antenna signals, or an “off-air” antenna signal received from local television transmission towers. The multi-switch is modified to include a modem which enables telephone line signals normally carried on a two-conductor wire pair to a telephone jack to modulate a carrier signal. The modulated carrier signal, which has a frequency below the lowest television signal frequency output by the multi-switch, e.g., lower than the 54 MHz, i.e., the lowest broadcast TV signal frequency, is summed with the satellite and off-air TV signals. The telephone signal modulated carrier is added in a summing amplifier to satellite and off-air TV signals, and output to a plurality of coaxial cable connectors. Each output connector is connected by a separate coaxial cable to a separate Integrated Receiver Decoder, IRD, each of which is typically connected to a television monitor.

The triplexer system includes a separate triplexer, or triple signal demultiplexer, or “splitter,” interposed between each coaxial cable and the monitor. The triplexer includes a diplexer, which consists of an RLC wave filter, to separate and direct to two separate output ports satellite signals for connection to the IRD and off-air broadcast antenna TV signals for routing directly to a television monitor. The triplexer also contains a phone-signal modem. The modem is connected to a telephone jack on the IRD, and allows conventional telephone signals to be communicated through the coaxial cable, from a telephone jack connected to the remotely located multi-switch box.

The above described triplexer system for solving the telephone jack access problem has not been widely adopted, because of its complexity and expense. Moreover, the operating mode of a conventional telephone is more complex than it appears, when the telephone rings, a 180 V d.c. 20-Hz square wave appears on the line. The loop voltage is typically 35 V d.c. on hook and typically 11V d.c. off-hook. The foregoing range of voltages requires complex and costly electronic circuitry to process. Also, the system requires a separate triplexer for each receiver.

Another approach to providing connectivity to a telephone jack located some distance from an IRD uses pairs of “power-plug” modems which are plugged into physically separated 120-volt AC power receptacles. Each modem has a 3.3 MHz-8.2 MHz FM modulated carrier signal, plus a digital FSK modulator, to convey telephone jack signals. A disadvantage of a “home plug” network of the type described above is that such systems are highly prone to interference from operation on the power lines of devices such as microwave ovens, hair dryers, stereos and computers. Moreover, most residences and businesses have multiple power line branches and it cannot always be assured that two power plug modems are plugged into the same circuit branch.

The present invention was conceived of to provide a highly effective and economical solution to provide telephone, ethernet or DSL connections to devices located where there is no convenient access to an existing telephone jack.

### OBJECTS OF THE INVENTION

An object of the present invention is to provide a method and apparatus for electrically interconnecting a downstream electronic device which is connected by a coaxial cable to an upstream electronic device to a telephone jack.

Another object of the invention is to provide a method and apparatus for electrically interconnecting a plurality of devices interconnected in a star arrangement by coaxial cables to form an auxiliary star network electrically isolated from the coaxial cables, for carrying telephone, DSL, or ethernet signals electrically isolated from the coaxial cables.

Another object of the invention is to provide a method and apparatus for routing auxiliary signals by auxiliary conductors fixed to the exterior of a coaxial cable.

Another object of the invention is to provide a method and apparatus for interconnecting a network connector such as a telephone jack on a device at a remote location which is connected to another location by a coaxial cable, to a network port such as a telephone jack connected to a land line at a different location, by conductors attached to the exterior of the coaxial cable, the conductors being bridged to corresponding wires on another coaxial cable at a location intermediate the remote and nearby locations.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, I do not intend that the scope of my exclusive rights and privileges in the invention be limited to details of the embodiments described. I do intend that equivalents, adaptations and modifications of the invention reasonably inferable from the description contained herein be included within the scope of the invention as defined by the appended claims.

### SUMMARY OF THE INVENTION

Briefly stated, the present invention comprehends a method and apparatus for routing auxiliary signals using coaxial cables, while maintaining electrical isolation between signals on the coaxial cable conductors and the auxiliary signals. The present invention facilitates interconnecting a network connector on an electronic device, such as a satellite receiver which is located an inconveniently large distant away from a network portal, to an existing network portal such as a telephone jack connected to a telephone land line, or to an ethernet jack connected to an ethernet network located at an accessible location.

According to the invention, a modified coaxial cable is prepared which has one or more pairs of fine insulated wires affixed to the exterior insulating jacket of the coaxial cable, thus forming a “piggy-back” carrier for auxiliary signals.

In a typical employment of a routing method according to the present invention, at a distal end of a coaxial cable which feeds, for example, a satellite receiver box, Integrated Receiver Decoder (IRD), or cable service provider cable box, insulated ends of the fine piggy-back wire pair are peeled away from the coaxial cable jacket, insulation stripped from the wires, and the bare conductors mechanically and electrically conductively secured to individual connector pins of a connector such as an RJ-11 telephone plug, which is then inserted into an RJ-11 telephone jack receptacle on the receiver device.

According to one aspect of the invention, ends of the auxiliary wire pair located at an upstream location of a coaxial cable, nearer to an existing network port such as a land-line telephone jack, are also stripped and fastened to an appropriate connector, which is then plugged into the network port.

According to another aspect of the invention, an upstream end of the coaxial cable carrying the piggy-back auxiliary conductor pairs is connected to an electronic device such as a LNB (Low Noise Block) converter located at the focus of a paraboloidal antenna dish used to receive signals transmitted from a satellite. In some satellite receiver installations, an LNB is provided with multiple output ports for connection via individual coaxial cables to multiple, physically separated receiver-box or IRD locations. In such installations, it is usually the case that at least one of the receiver boxes Is located nearer to an existing telephone wall jack, ethernet port, or other network port, than other receiver boxes. Therefore, according to the invention, ends of a piggy-back wire pair at an end of a coaxial cable connected to a “nearby” receiver located closest to the existing telephone jack or other network port are connected to an RJ-11 telephone plug or other network connector, and plugged into the jack.

At an intermediate location between nearby and remote receivers, e.g., in the vicinity of a multiple-output LNB, ends of the piggy-back wire pairs located at the upstream, or feed-end of the nearby receiver coaxial cable, are stripped. Also, wire ends of the piggy-back wire pairs located at the upstream end of the remote receiver coaxial cable are stripped. Corresponding conductive ends of the two wire pairs, e.g., green-green, red-red are then quickly and simply interconnected by any suitable means, such as by a pair of wire nuts. By the foregoing novel method, a “phone-bridge” connection is made, which provides a highly convenient method for interconnecting a remote electronic device such as a satellite receiver or cable box to a distant telephone jack, ethernet connector, or other such network portal.

According to another aspect of the present invention, an apparatus is provided to facilitate establishing a phone-bridge network connection of the type described above. In its basic form, the apparatus consists of an elongated insulated block which has protruding inwardly into a face thereof a plurality of regularly spaced apart connectors, such as telephone jacks. Corresponding terminals of the connectors are connected in parallel by conductors within the block.

The phone-bridge block is used by positioning it near coaxial signal output connectors of a satellite multi-switch router box. Each satellite receiver box or IRD in a given installation is then connected via a separate piggy-back coaxial cable to a separate one of the coaxial signal output connectors on the satellite multi-switch box. The distal ends of piggy-back wire pairs located at the end of each coaxial cable connected to an IRD are stripped and connected to an RJ-11 telephone plug, which is then inserted into an RJ-11 jack on the IRD.

At the multi-switch box, the ends of each piggy-back wire pair are stripped and connected to a separate RJ-11 plug, which is then inserted into one of the RJ-11 jacks on the phone-bridge block.

The foregoing arrangement is made for each satellite receiver box or IRD except for a “nearby” IRD located closest to an existing telephone jack. For that closest, nearby IRD, the RJ-11 plug connected to the ends of the piggy-back wire pair is inserted into one input jack of a duplex RJ-11 adapter which has a pair of parallel input jacks and a single output plug which is inserted into a RJ-11 wall jack connected to a telephone land-line. The other input jack of the duplex connector has plugged into it one end plug of a male-male RJ-11 cable, the other end plug being inserted into an RJ-11 jack of the nearby IRD. With this arrangement, the phone-bridge apparatus according to the present invention enables multiple remote satellite receiver boxes or IRD's to be interconnected to a nearby telephone land-line or other such network port.

In an alternate embodiment of a phone-bridge apparatus according to the present invention, the connector block is included as an integral part of a satellite multi-switch box.

### BRIEF DESCRIPTION OF THE DRAWINGS

FIG. 1 is a partly diagrammatic view of a prior art apparatus for interconnecting a remote satellite receiver to a telephone line.

FIG. 2 is an electrical block diagram of the apparatus of FIG. 1.

FIG. 3 is a perspective view of a basic embodiment of a phone-bridge auxiliary signal routing apparatus according to the present invention, in which the apparatus is used to interconnect a first satellite receiver where no telephone jack is available to an existing telephone jack located nearby a second satellite receiver.

FIG. 4 is a partly diagrammatic view of a modification of the apparatus of FIG. 3, which uses only a single satellite receiver that is located a substantial distance away from an existing telephone jack.

FIG. 5 is a partly diagrammatic view of another embodiment of the invention, in which the adapter box of FIG. 4 is integral with a multi-switch box.

FIG. 6 is an electrical block diagram of the apparatus of FIG. 5.

FIG. 7 is a partly diagrammatic view of an embodiment of the present invention which utilizes a separate phone-bridge adapter block adjacent to the coaxial output terminals of a multi-switch satellite router box to connect telephone ports of a plurality of satellite receivers which are remote from a telephone jack, to a telephone jack located near one of the satellite receivers.

FIG. 8 is a partly diagrammatic view of an embodiment of a phone-bridge apparatus according to the present invention which is used with a coaxial cable distribution box.

FIG. 9 is a partly diagrammatic view of another embodiment of the invention which is used with a cable distribution box or satellite Integrated Receiver Decoder (IRD) system on a multiple conductor network such as ethernet.

FIG. 10 is an elevation view of a prior art coaxial cable provided with a pair of control wires.

FIG. 11 is an elevation view of a modified, piggy-back coaxial cable for use with the phone-bridge apparatus according to the present invention.

FIG. 12 is a transverse sectional view of the cable of FIG. 11.

FIG. 13 is a transverse sectional view of a modification of the cable of FIGS. 11 and 12, which is provided with multiple auxiliary signal wire pairs.

### DESCRIPTION OF THE PREFERRED EMBODIMENTS

An appreciation of some of the most novel features and advantages of the present invention may be best obtained by considering a prior art method of providing connectivity between remotely located satellite receiver boxes and a telephone land line.

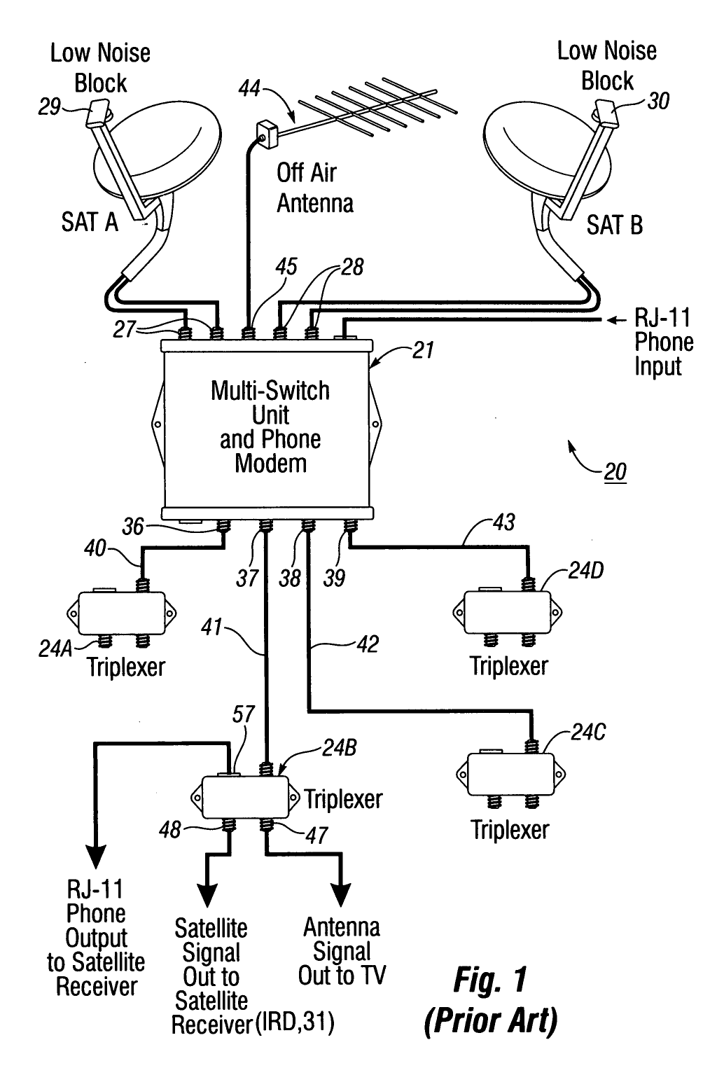

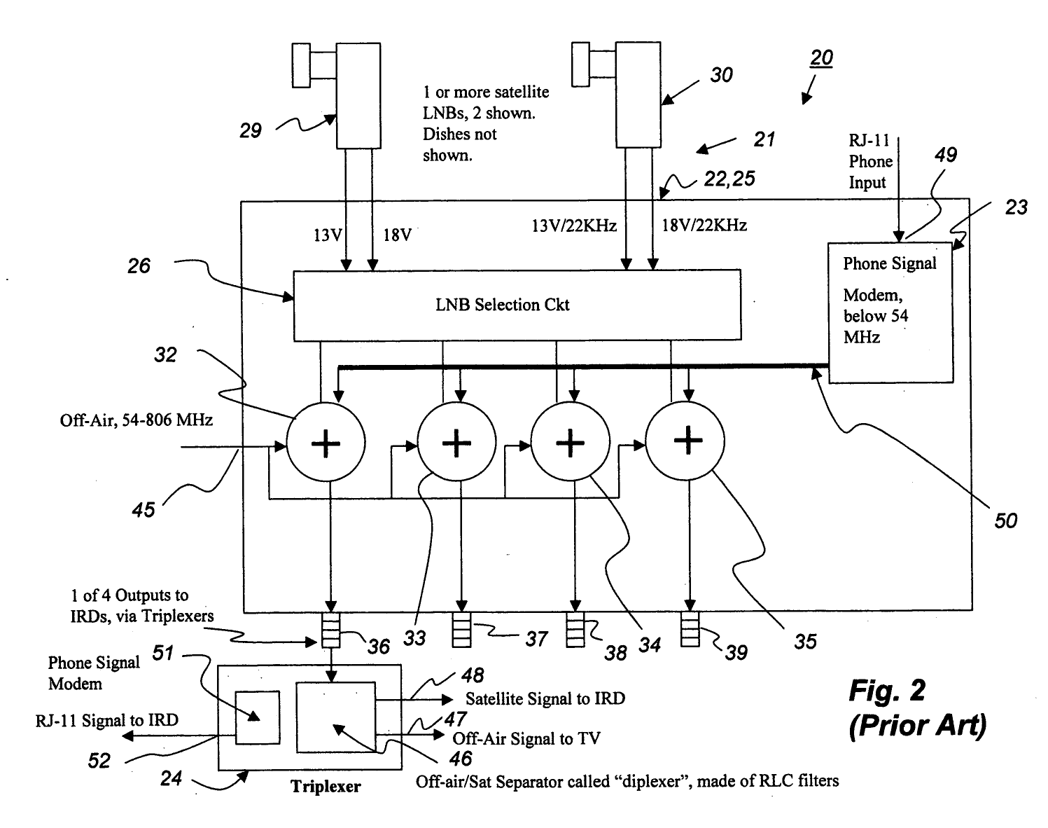

Thus, FIGS. 1 and 2 illustrate a prior art, “triplexer” system for connecting multiple remotely located satellite receiver boxes, or Integrated Receiver Decoder (IRD's) to a telephone land line.

As shown in FIGS. 1 and 2, a triplexer phone connectivity system 20 for use with multiple satellite receiver boxes, or IRD's, includes a multi-switch/modem unit 21 that has a modified multi-switch unit 22 and a phone modulator 23. The system requires a separate “triplexer” demodulator module 24 for connection to each IRD.

As may be understood best by referring to FIG. 2, multi-switch/phone modem unit 21 includes a multi-switch subsystem 25 of relatively conventional design and operation, and a phone signal modulator 23.

Multi-switch subsystem 25 includes an LNB (Low Noise Block) selection circuit block 26, which has two inlet ports 27, 28 that are connected to two separate LNB converters 29, 30, one of which is located at the focus of a satellite dish antenna A, and one at the focus of satellite dish antenna B. Selection circuit block 26, responsive to signals input through a triplexer 24 from an IRD (not shown), selects, for example, right-hand or left-hand circularly polarized signals (or vertically/horizontally polarized signals) from satellite dish antenna A, 29, depending on whether a control signal line has a voltage of 13 or 18 volts. If the signal control line has a 22 KHz control signal superimposed thereon, signals from satellite dish antenna B. 30, are selected. Selected satellite output signals from selection circuit block 26 are input to separate summing amplifiers 32, 33, 34, 35, output terminals of which are connected to coaxial signal output connectors 36, 37, 38, 39, respectively, on multi-switch/modem unit 21. Output connectors 36, 37, 38, 39 are connected through coaxial cables 40, 41, 42, 43 to triplexers 24A, 24B, 24C, 24D, respectively.

Multi-switch subsystem 25 has two pairs of satellite input ports, one off-air input port, and four cable output ports, and hence is referred to as a “five by four” or 5×4 multi-switch. Other multi-switches may have different numbers of ports, e.g., 3×4, 4×8, 4×16, 6×8, 6×16, etc.,

As shown in FIGS. 1 and 2, an “off-air” antenna 44 for receiving broadcast television signals from local TV broadcast transmission antenna towers has an output signal input via an input connector 45 to multi-switch/modem unit 21. Input connector 45 is electrically connected to input terminals of summing amplifiers 32, 33, 34, 35. As shown in FIG. 2, each triplexer 24 includes a diplexer 46 which has an RLC electrical wave filter that outputs lower frequency, i.e., 54-MHz to 806-MHz, broadcast television signals on off-air signal output terminal 47 to a television set. Diplexer 46 of triplexer 34 also outputs satellite television signals of 950-MHz and above through output terminal 48 to an IRD (not shown).

As thus far described, prior art multi-switch/telephone modem unit 21 has the structure and function of a conventional satellite multi-switch. However, unit 21 also includes a telephone signal modem block 23. The latter has an input port 49 which is connectable to a telephone land-line RJ-11 phone jack, and an input port 50 which is connected to a third input terminal of each summing amplifier. Telephone modem 23 generates a carrier signal which has a frequency lower than 54 MHz and is modulated by telephone line signals input to the modem. Thus, output terminals of the summing amplifiers 32, 33, 34, 35 have thereon a telephone carrier signal modulated by telephone land-line signals. Also, each summing amplifier output terminal is connected through buffer amplifier (not shown) to phone modem block 23, thus allowing transmission of telephone line signals on output connectors 36, 37, 38, 39 of unit 21.

Referring to FIG. 2, each triplexer 24 includes a downstream modem 51 which has a telephone plug output port 52 that is connectable to the telephone input jack of an IRD. This arrangement provides connectivity between an IRD and an RJ-11 phone jack connected to the multi-switch/phone modem apparatus 21.

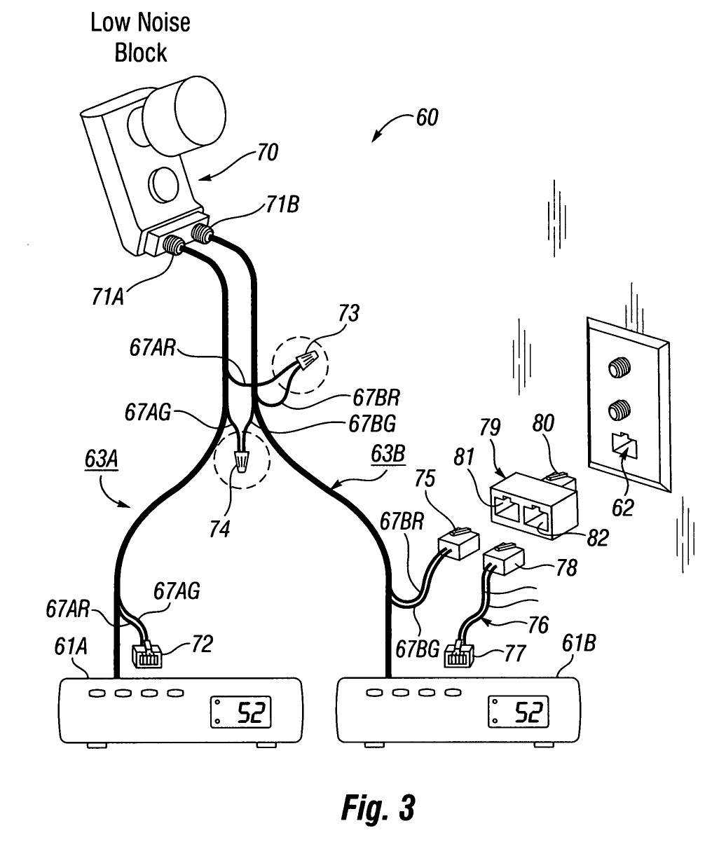

FIG. 3 is a perspective view of a basic embodiment of a phone-bridge auxiliary signal routing apparatus 60 according to the present invention. The apparatus configuration in FIG. 3 is suitable for use in interconnecting a first remote satellite receiver box or Integrated Receiver Decoder (IRD) 61A to a telephone jack 62 hard-wired to a telephone land line, and located a substantial distance away from the first IRD 61A.

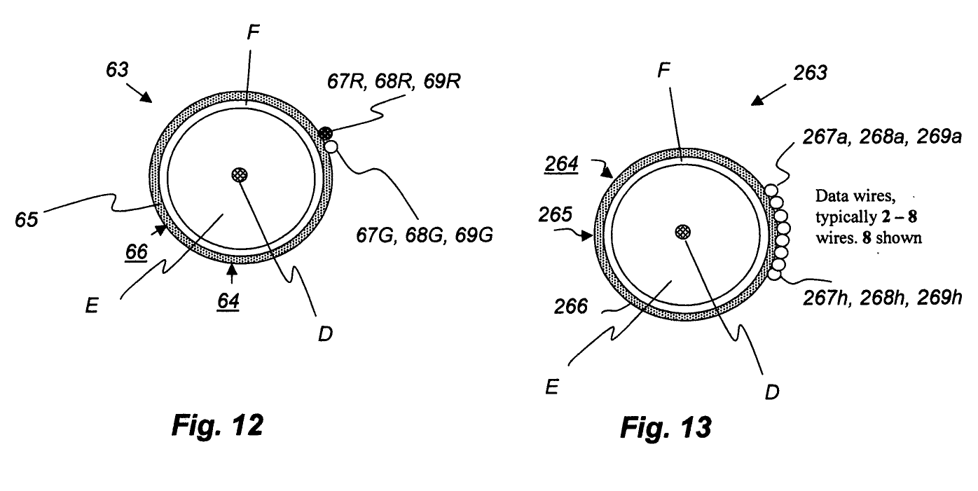

Phone-bridge apparatus 60, shown in FIG. 3, utilizes a coaxial cable 63 of novel construction, which is shown in FIGS. 11 and 12.

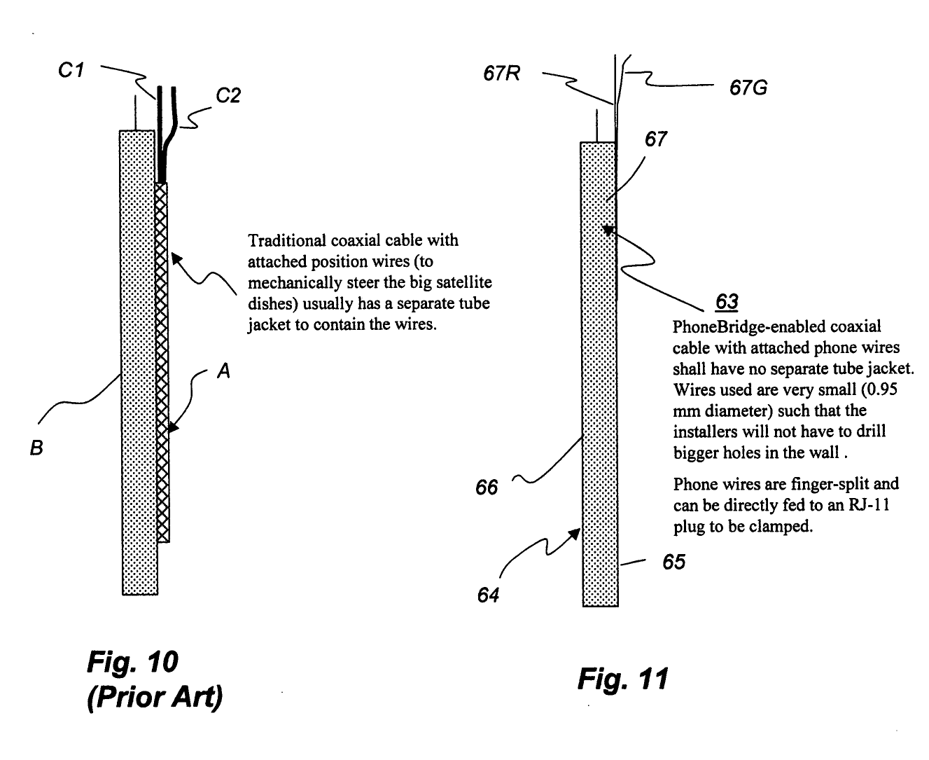

As shown in FIG. 10, there are available prior art coaxial cables which have affixed to the exterior of coaxial cable insulating jacket B thereof a pair of insulated control wires C1, C2, in their own insulating jacket A. Typically, these control wires, which are used to provide power and positioning signals to a motor-driven antenna, have a relatively large diameter, such as 20 AWG or bigger to carry currents. The diameter of insulated 20 AWG wire is 0.071 inch (1.8 mm). The typical overall diameter of the two control sires plus their outer jacket is 0.142 inch (3.6 mm). Now, the outer diameter of a standard RG-6 coaxial cable is about 0.27 inch to 0.30 inch (6.86 mm-7.62 mm). Therefore, the maximum outline diameter of a prior art coaxial cable provided with 20-gauge control wires is increased by 53 percent. Accordingly, prior art coaxial RG-6 cables with external control wires cannot be conveniently deployed through structures which have been provided with holes just sufficiently large in diameter to receive a standard RG-6 coaxial cable. And, since the modified coaxial cable 63 according to the present invention is intended to replace standard RG-6 cable in installations which have been provided with clearances just slightly larger than the diameter of a standard RG-6 coaxial cable, modified cable 63 has a substantially reduced outer envelope diameter.

Thus, as shown in FIGS. 11 and 12, modified coaxial cable 63 includes a standard RG-6 cable 64 which has a center conductor D, a dielectric core E, a braided conductive metal sheath F, and an outer insulating jacket 66. Modified coaxial cable 63 has affixed to outer surface 65 of outer insulating jacket 66 thereof a pair of auxiliary signal wires 67R, 67G. Wires 67 have stranded conductors 68, typically 24-26 AWG, and have a copper diameter of 0.02 inch (0.5 mm). Conductors 68 are encased in separate colored jackets 69, e.g., red and green jackets 69R, 69G, made of a flexible, non-combustible polymer such as polyethylene (PE), polyvinyl chloride (PVC) or the like, which has an outer diameter of about 0.037 inch (0.94 mm) or less. Thus, for a standard RG-6 cable 64 which has an outer diameter of about 0.29 inch (7.45 mm). Modified coaxial cable 63 has a maximum outline dimension of only about 0.94/7.57=12.0% larger than a standard RG-6 coaxial cable. This small size increase is within the high-side tolerance of a standard RG-6 cable. Additionally, the auxiliary wires are stranded and compressible. Therefore, modified coaxial cable 69 will fit through holes drilled to accommodate standard RG-6 cables.

Referring again to FIG. 3, phone-bridge apparatus 60 according to the present invention is configured as follows:

As shown in FIG. 3, phone-bridge apparatus 60 is used in an installation which includes a dual Low Noise Block (LNB) converter 70 located at the focus of a parabolical satellite dish antenna (not shown). LNB 70 has a pair of coaxial output signal connectors 71A, 71B for interconnecting to separate satellite receiver boxes or Integrated Receiver Decoders (IRD's) 61, located at different locations, e.g., a living room and a bedroom.

As shown in FIG. 3, a first, remote satellite receiver box or IRD 61A is located a substantial distance away from a telephone jack 62 hard-wired to a telephone land-line. IRD 61A has a coaxial signal interface connector (not shown) which is connected to LNB coaxial connector 71A by a first length of modified coaxial cable 63A. At the downstream end of cable 63A near IRD 61A, the end portions of auxiliary wires 67AR, 67AG are peeled away from the cable jacket 66, the tips of insulating jackets 69 stripped from conductors 68 of the wires, and the conductors secured electrically and mechanically to separate conductive pins of an RJ-11 telephone plug 72. The latter is then plugged into an RJ-11 jack (not shown) in a back panel (not shown) of IRD 61A.

Referring still to FIG. 3, it may be seen that apparatus 60 includes a second, “nearby” satellite receiver box or IRD 61B which is located nearby, i.e., closer to, telephone jack 62 than IRD 61A. IRD 61B is connected to LNB connector 71B by means of a second length of modified coaxial cable 63B.

At a location where cables 63A and 63B are closest together, i.e., near signal connectors 71A, 71B of LNB 70, auxiliary wires 67AR, 6AG are peeled from cable 63A and stripped. Similarly auxiliary wires 67BR, 67BG are peeled from cable 63B and stripped. The wires 67 at the LNB ends of cables 63A, 63B are then interconnected, using, for example, a first wire nut 73 to interconnect red wires 67AR and 67BR, and a second wire nut 74 to interconnect green wires 67AG and 67BG. The foregoing interconnections comprise a “phone-bridge” between cables 63A and 63B, and therefore between IRD 61A and auxiliary conductors 67BR, 67BG of modified cable 63B. Those auxiliary conductors are used to complete connection between the phone-bridge and telephone land-line jack 62, as follows.

Referring still to FIG. 3, it may be seen that at the downstream end of cable 63B, near IRD 61B, auxiliary conductors 67BR, 67BG are connected to an RJ-11 telephone plug 75, in the same manner as the connections of auxiliary conductors 67AR, 67AG to RJ-11 telephone plug 72. As is also shown in FIG. 3, apparatus 60 includes a two-wire interconnect cable 76 which has at opposite ends thereof RJ-11 telephone plugs 77, 78, respectively. Apparatus 60 also includes a duplex two-jack to one plug RJ-11 adapter 79. Adapter 79 has a single output plug 80, and input jacks 81, 82, which have pairs of conductive pins that are connected in parallel with conductive pins of the plug.

As can be readily appreciated, when plug 75 is inserted into jack 81 of duplex adapter 79, and plug 80 of the duplex adapter plugged into telephone land-line jack 62, connectivity is established between the telephone line and remote IRD plug 72. Also, connectivity between IRD 61B and telephone land-line jack 62 is established by inserting plug 77 of adapter cable 76 into an RJ-11 interface jack (not shown) on the back panel (not shown) of IRD 61B, and plug 78 of the adapter cable 76 inserted into jack 82 of duplex adapter 79. This last step completes the configuration of apparatus 60 to thus establish an electrical connection between telephone jack 62 and IRD 61A.

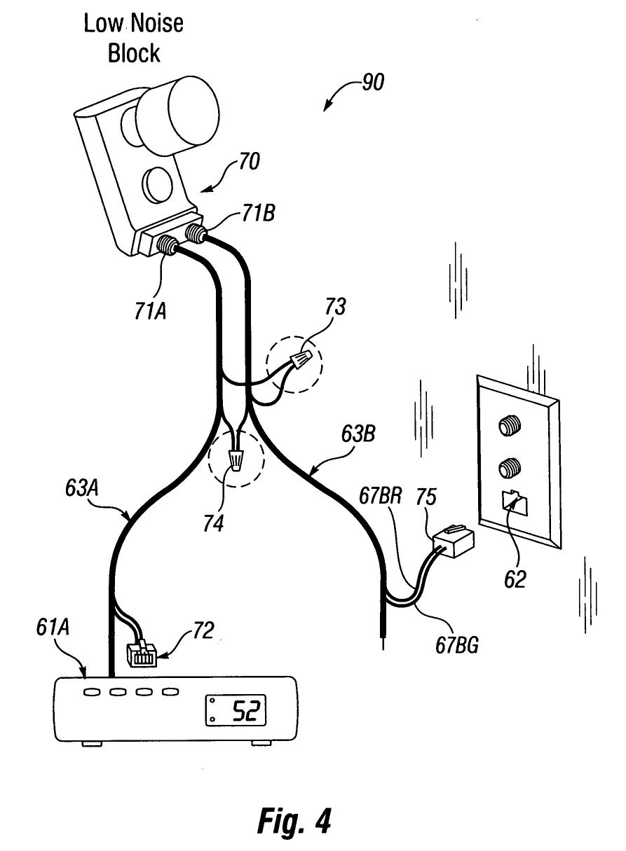

FIG. 4 illustrates another embodiment 90 of a phone-bridge apparatus according to the present invention. That embodiment is suitable for applications in which a single IRD 61A is located an inconvenient distance away from a telephone jack 62. In the embodiment 90, connectors such as wire nuts 73, 74 are used to make a phone-bridge connection between auxiliary conductors 67AR, 67AG of coaxial cable 63A, and auxiliary conductors 67BR, 67BG of coaxial cable 63B, exactly as described above for embodiment 60 and shown in FIG. 3. However, for the single IRD 61A installation 90 of FIG. 4, there is no IRD located at te downstream end of coaxial cable 63B, which is positioned near an existing telephone jack 62. In this case, RJ-11 telephone plug 75 which terminates a downstream end of auxiliary cable conductors 67BR, 67BG is plugged directly into existing RJ-11 telephone jack 62. This last step completes the configuration of apparatus 90 to thus establish an electrical connection between telephone jack 62 and IRD 61A.

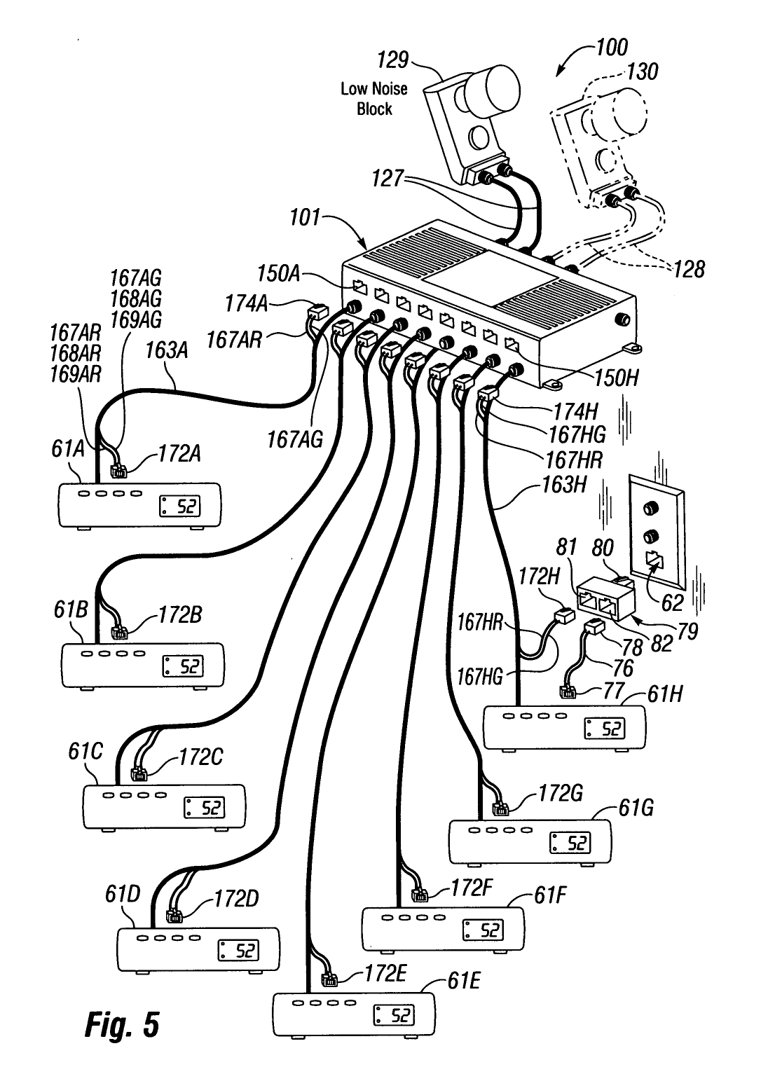

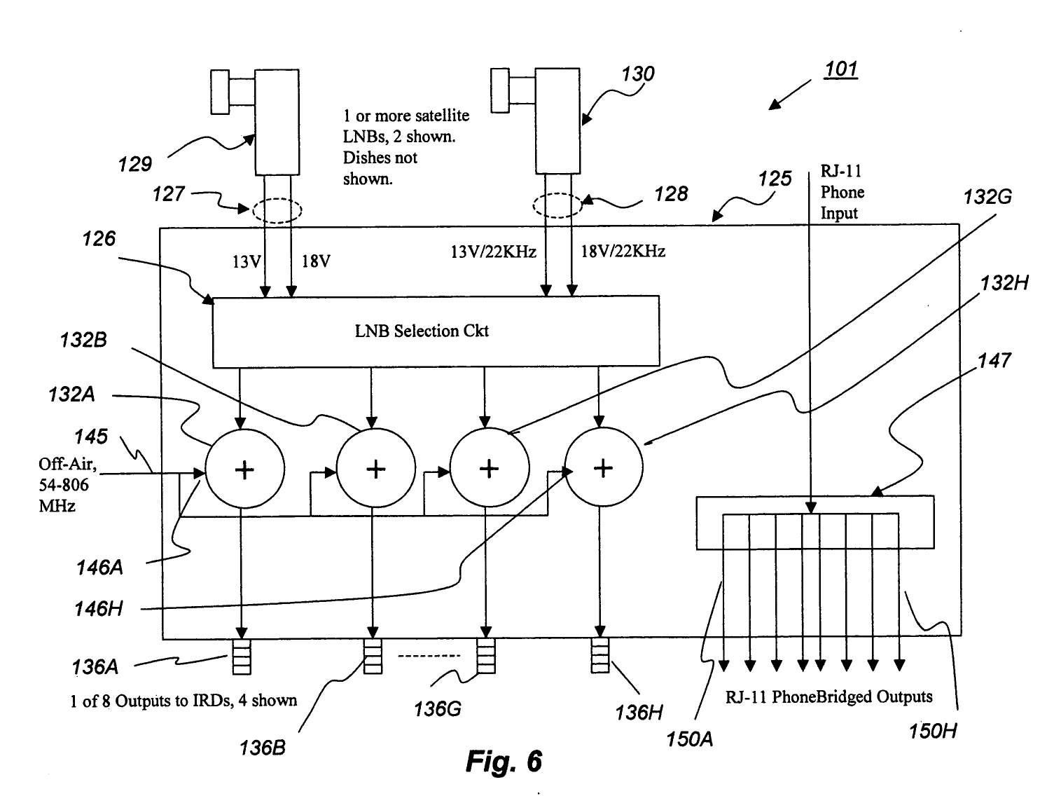

FIGS. 5 and 6 illustrate another embodiment 100 of a phone-bridge apparatus according to the present invention. That embodiment is suitable for use connecting a number of physically separated satellite receiver boxes, or IRD's 61 to a telephone jack using a phone-bridge method according to the present invention.

As shown in FIG. 5, phone-bridge apparatus 100 according to the present invention includes a phone-bridge interface box 101. As shown in FIG. 6, phone-bridge interface box 101 is a modification of a conventional satellite receiver multi-switch router box. Thus, as shown in FIG. 6, phone-bridge interface box 101 preferably includes a conventional multi-switch subsystem 125 that has an LNB (Low Noise Block) selection circuit 126 which has two input ports 127, 128 that are connected to two separate LNB converters 129, 130, one of which is located at the focus of a satellite dish antenna A, and one at the focus of a satellite dish antenna B.

Multi-switch subsystem 125 includes a plurality of summing amplifiers 131A-131H which each have input an terminal that is connectable to antenna A LNB, 129 or antenna B LNB, and receives horizontally or vertically polarized satellite television signals therefrom. Selection of antenna and signal polarization is made by a control signal which is input from a remote IRD 61A-61H, conveyed through a cable 63A-61F to an interface box output connector 136A-136H and through a bidirectional buffer amplifier (not shown) at the output terminal of summing amplifiers 131A-131H. Control signal values of 13 or 18 volts select right or left-hand circularly polarized (or vertically/horizontally polarized) signals received by antenna A LNB, while a 22-KHz signal superimposed on the control signal selects signals from antenna B LNB.

As shown in FIG. 6, multi-switch subsystem 125 includes an input connector 145 which is connectable to an antenna for receiving “off-air” broadcast television signals from local TV broadcast transmission towers. An output terminal of connector 145 is connected to input terminals 146A-146H of summing amplifiers 132A-132H.

As shown in FIGS. 5 and 6, phone-bridge interface box 101 of phone-bridge apparatus 100 includes a phone jack block 147. The latter includes a longitudinally elongated, block-shaped member 148 which has a front face 149 in which are inset a plurality of longitudinally spaced apart RJ-11 phone jacks 150. Corresponding conductive pairs of each of the phone jacks 150 are connected in parallel by a pair of wires (not shown).

The example embodiment of phone-bridge interface box 101 shown in FIGS. 5 and 6 is adapted to accommodate up to eight separate IRD's, and therefore has 8 RJ-11 phone jacks 150A-150H. Of course, any number of jacks could be used, corresponding to the number of IRD's the apparatus is intended to be used with.

As shown in FIG. 5, an IRD 61 closest to a land-line connected telephone jack 62, such as IRD 61H, is connected to a coaxial multi-switch output connector, such as connector 136H on phone-bridge interface box 101 via a modified coaxial cable 163H. At the downstream end of cable 163H, auxiliary conductors 167HR, 167HG are interfaced to telephone jack 62 through a duplex adapter 81 exactly as shown in FIG. 3 and described above for embodiment 60 of the apparatus. Also, IRD 61 H is interconnected to jack 62 through duplex adapter 81 via a double-plug cable 76, as also shown in FIG. 3 and described above.

Referring again to FIG. 5, it may be seen that modified coaxial cable 163H has at an upstream end thereof, near interface box 101, auxiliary conductors 167HR, 167HG peeled off from the cable jacket, and mechanically and electrically conductively connected to an RJ-11 telephone plug 174H. As is also shown in FIG. 5, at a downstream end of modified coaxial cable for connection to a remote satellite receiver box or IRD, such as cable 163A for connection to IRD 61A, auxiliary wires 167AR, 167AG are peeled away from the cable 163A, the tips of the insulating jackets 69 (FIG. 12) stripped from the conductors 68 (FIG. 12) of the wires, and the conductors secured electrically and mechanically to separate conductive pins of an RJ-11 telephone plug 172A. The latter is then plugged into an RJ-11 jack (not shown) provided in a back panel (not shown) of IRD 61A.

At the upstream end of cable 163A for remote IRD 61A, the ends of auxiliary wires 167AR, 167AG are peeled, stripped and connected to an RJ-11 plug 174A.

Finally, plugs 174A and 174H are plugged into any pair of jacks 150 of interface box 101, such as jacks 150A, 150H. This last step completes configuration of apparatus 100 shown in FIGS. 5 and 6, and establishes the desired phone-bridge connection between any remote IRD, such as remote IRD 61A, and an accessible telephone jack 62. In exactly the same manner, any or all of a plurality of additional IRD's, such as IRD's 61B-61G may be interconnected to phone jack 62 using interface box 101 of apparatus 100.

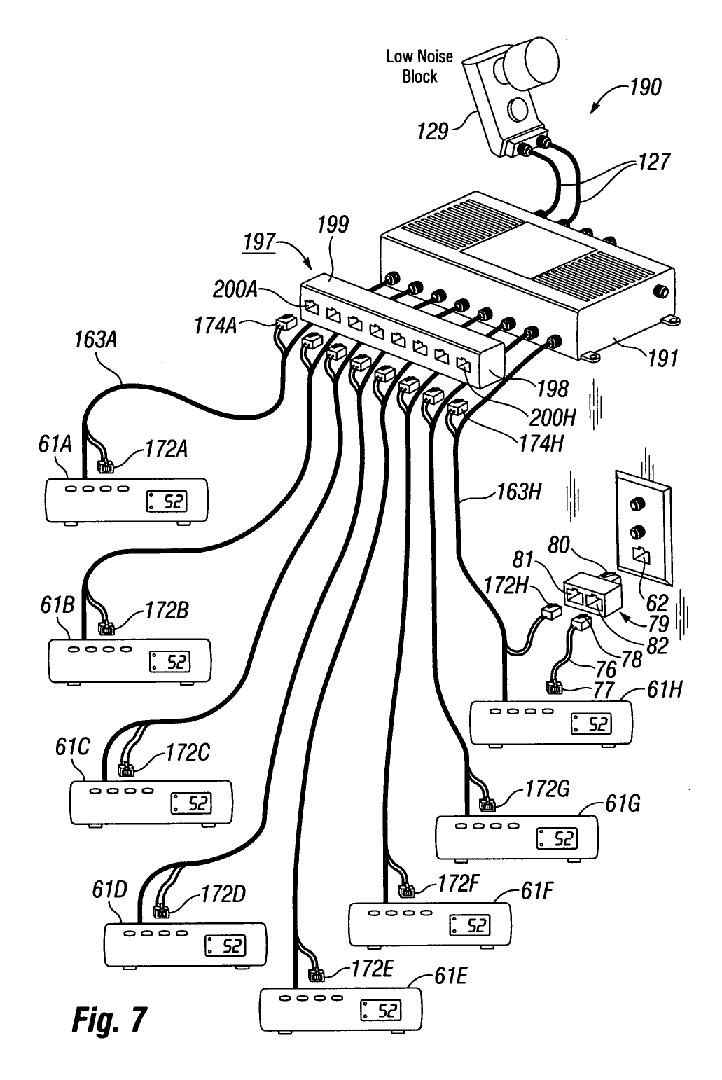

FIG. 7 illustrates another embodiment 190 of a phone-bridge apparatus according to the present invention. Embodiment 190 is substantially similar in structure and function to apparatus 100 shown in FIGS. 5 and 6 and described above. However, embodiment 190 utilizes a phone jack connector block 197 which is located exteriorly to a conventional, unmodified multi-switch box 191. Phone jack connector block 197 includes a longitudinally elongated block 198 which has in a front face 199 thereof a plurality of two or more longitudinally spaced apart RJ-11 phone jacks 200. Apparatus 190 is used by locating phone jack connector block 197 in the vicinity of satellite receiver router box 191, e.g., in front of a front panel of the box. As shown in FIG. 7, phone-bridge apparatus 190 is used by preparing two or more modified coaxial cables, e.g., 163A, 163H, and plugging corresponding RJ-11 plug connectors 174A, 174H at upstream ends of the cables into corresponding RJ-11 jack connectors 200A, 200H on front face 199 of phone jack connector block 197.

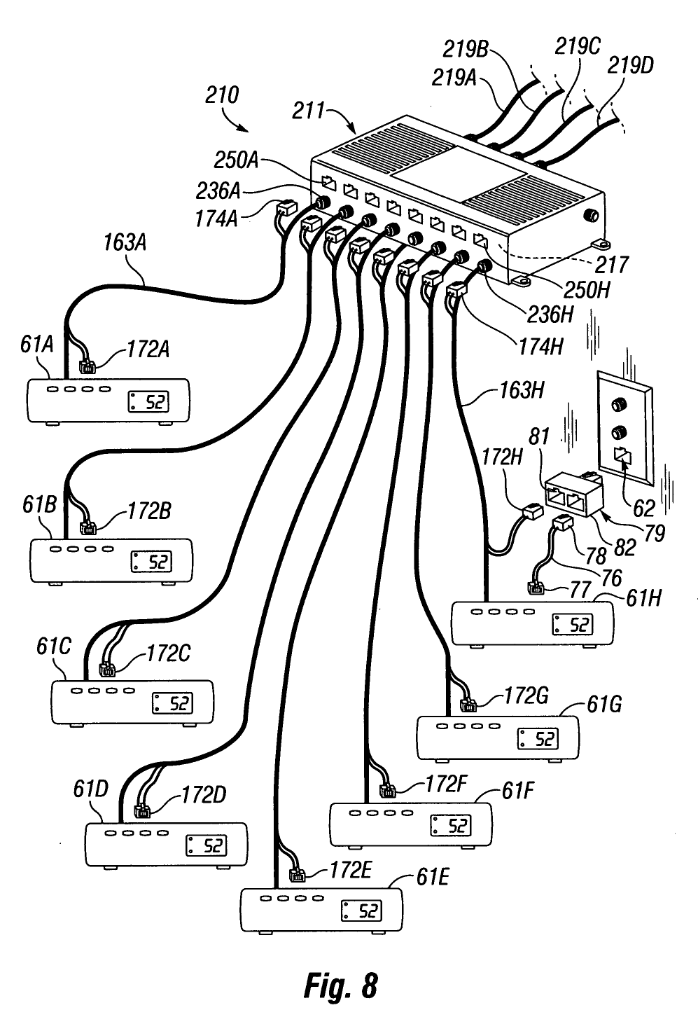

FIG. 8 illustrates another embodiment 210 of a phone-bridge apparatus, according to the present invention. Phone-bridge apparatus 210 is used in conjunction with a cable television subscriber service, in which a cable service provider cable 219 is input to a building from an exterior location such as a street conduit.

As shown in FIG. 8, phone-bridge apparatus 210 includes a conventional cable subscriber distribution box or IRD box 211, which is modified by installation therein of a phone jack connector block 217 which has a structure and function identical to phone jack connector block 147 of apparatus 100 shown in FIGS. 5 and 6 and described above. Apparatus 210 functions in exactly the same manner as apparatus 100, as has been described above.

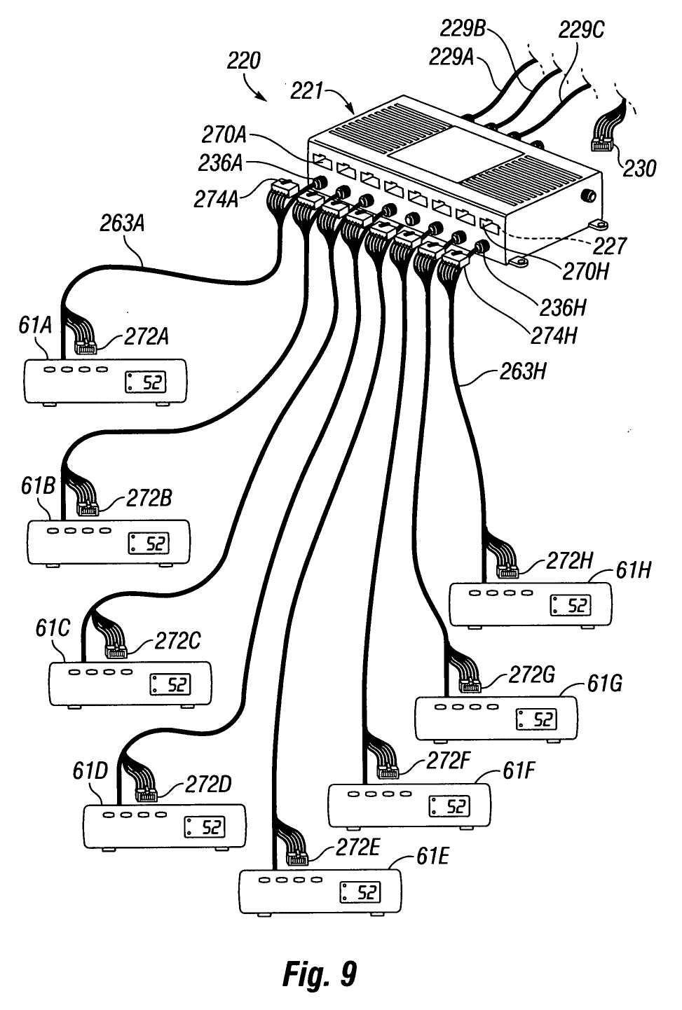

FIG. 9 illustrates another embodiment 220 of a phone-bridge apparatus according to the present invention. That embodiment is used in conjunction with an ethernet LAN (Local Area Network) or other such communication network, which is used with a coaxial signal lines 229A, 229B, 229C, etc. that distributes coaxial signals to a plurality of receiving devices.

As shown in FIG. 9, an ethernet network cable 230, which is connected to a Local Area Network (LAN) or the like, is connected to a distribution hub box 221, which has been modified by installation therein of an ethernet connector plug block 227 that has a structure and function similar to phone jack connector block 147 of apparatus 100 shown in FIGS. 5 and 6 and described above.

However, as those skilled in the art will readily recognize, the protocol requirements for certain network interconnections such as Ethernet require more elaborate bridging circuitry rather than a simple parallel connection of corresponding conductors, e.g., red and green, as described above for a standard RJ-11 telephone interconnection. Thus, bridging circuitry within apparatus 220 is provided which is suitable for the particular LAN protocol, such as Ethernet protocol, that the apparatus is intended to be used with. For example, bridging circuitry of apparatus 220 for use with an Ethernet network may include electronic signal interfacing circuitry which typically has a microprocessor for providing input/output (I/O) control of transmitted data, received data, and collision detection data signals on three separate pairs of auxiliary wires 267, and optionally a fourth pair for providing power to distribution hub box 221. Such Ethernet interfacing methods are well known to those skilled in the art and are described for example in Schweber “Electrical Communication Systems,” 1991, Prentice Hall, Inc. Englewood Cliffs, N.J. 03632, pp. 563-565.

Constructed as described above, apparatus 220 enables “phone-bridge” type ethernet interconnections to be made between a plurality of physically separated electronic devices, (such as IRD's 61A-61H), using lengths of a modified coaxial cable 263. As shown in FIG. 13, modified coaxial cable 263 includes a standard cable, e.g., an RG-6 coaxial cable 264 which has affixed to outer surface 265 of outer insulating jacket 266 thereof pairs, typically 3 or 4, of auxiliary signal wires 267a-267h. Wires 267 preferably have a construction similar to that of auxiliary telephone wires 67 described above, and include conductors 268 encased in separate, individually color-coded insulating jackets 269.

Optionally, auxiliary wires 67, 267 of modified coaxial cables 63, 263, respectively, could be contained within a single tubular jacket adhered to surface 65 of cable jacket 66, 266. The “phone-bridge” methods and apparatus according to the present invention and described above, provide a simple, inexpensive, and easily implemented method of providing bi-directional telephone communications to an electronic device located a substantial distance away from a telephone jack. In tests made by the present inventor, it was determined that bidirectional telephone communications could be established and maintained by the method and apparatus of the present invention for cable lengths as great as 300 feet or more.

An important feature of the present invention is that fact that using the modified coaxial cable according to the present invention in place of conventional RG-6 coaxial cables in installation such as satellite or cable television installations in a home or office, automatically provides a future upgrade capability for making phone-bridge interconnections between an accessible phone jack and a remote satellite or cable receiver box. This upgrade may be implemented by simply replacing an existing multi-switch box or similar device with one modified by the addition of a phone connection block, or by positioning an external phone connector block adjacent to the multi-switch box, and connecting phone plugs to the ends of auxiliary wires, as described above.

What is claimed is:

1. An apparatus for interconnecting at least a first auxiliary electrical signal conductor between a downstream electronic device and an auxiliary network port using an intermediate device situated at a location closer to said auxiliary network connector than said downstream electronic device, said apparatus comprising in combination;
a. first and second primary signal cables of modified construction, said modified construction including at least a first insulated auxiliary conductor affixed to said primary signal cable,
b. a downstream-device electrical connector connected to a downstream end of said auxiliary conductor affixed to said first modified cable, said downstream device electrical connector being adapted to connect to an auxiliary connection port of said downstream electronic device,
c. a network port connector connected to a downstream end of said auxiliary conductor affixed to said second modified cable, said network port connector being adapted to connect to said network port, and
d. bridging circuitry for electrically interconnecting an upstream end of said auxiliary conductor of said first modified cable with an upstream end of a corresponding auxiliary conductor of said second modified cable.

2. The apparatus of claim 1 wherein said downstream device electrical connector of said first modified cable is further defined as being one of a plug and mating jack pair.

3. The apparatus of claim 1 wherein said network port connector of said second modified cable is further defined as being one of a plug and mating jack pair.

4. The apparatus of claim 3 wherein said downstream device electrical connector of said first modified cable is further defined as being of the same type as said network port connector of said second modified cable.

5. The apparatus of claim 4 wherein said network port connector of said second modified cable, and said downstream device electrical connector of said first modified cable are both defined as being telephone plugs.

6. The apparatus of claim 4 wherein said modified construction of said first and second signal cables includes at least a second insulated auxiliary conductor affixed to said outer surface of said primary signal cable.

7. The apparatus of claim 6 wherein said primary signal cable is further defined as being a coaxial cable.

8. The apparatus of claim 1 wherein said bridging circuitry is further defined as comprising at least a first bridge connector adapted to interconnect a single pair of corresponding auxiliary signal wires.

9. The apparatus of claim 8 wherein said first bridge connector is further defined as being a wire nut.

10. The apparatus of claim 1 wherein said bridging circuitry is further defined as comprising in combination;
a. a first connector component comprising one of a plug and jack mating pair, connected to said upstream end of said auxiliary wire of said first modified cable, and
b. a second connector component comprising a complementary one of said one of a plug and jack mating pair adapted to mate with said first connector component, said second connector component being connected to said upstream end of said second modified cable.

11. The apparatus of claim 1 wherein said bridging circuitry is further defined as comprising;
a. a first, first-type connector component comprising one of a plug and jack mating pair connected to said upstream end of said auxiliary wire of said first modified cable,
b. a connector block comprising a plurality of parallel-wired second type connector components each comprising a complementary one of said plug and jack mating pair, each of said second type connector components adapted to mate with said first type connector component, and
c. a second, first-type connector component connected to an upstream end of said auxiliary wire of said second modified cable, said second first-type connector component being of the same type as said first connector and adapted to mate with another of a said plurality of said second-type connector block connectors.

12. The apparatus of claim 11 wherein said first-type of connector component is further defined as being a telephone plug.

13. The apparatus of claim 12 wherein said second-type connector component is further defined as being a telephone jack.

14. The apparatus of claim 13 wherein said modified construction of said first and second signal cables includes at least a second insulated auxiliary conductor affixed to said outer surface of said primary signal cable.

15. The apparatus of claim 14 wherein said primary signal cable is further defined as being a coaxial cable.

16. The apparatus of claim 1 wherein said bridging circuitry is further defined as including electronic signal interfacing circuitry which conforms to a particular network protocol.

17. The apparatus of claim 16 wherein said network protocol is further defined as Ethernet protocol.

18. A method for interconnecting at least a first auxiliary signal conductor between a downstream electronic device and an auxiliary network port using an intermediate device situated at a location closer to said auxiliary network connector than said downstream electronic device, said method comprising the steps of:
a. providing first and second primary signal cables of modified construction, said modified construction including at least a first insulated auxiliary conductor affixed to said primary signal cable,
b. providing a downstream electrical connector connected to a downstream end of said auxiliary conductor affixed to said first modified cable, said downstream device electrical connector being adapted to connect to an auxiliary connection port of said downstream electronic device,
c. providing a network port connector connected to a downstream end of said auxiliary conductor affixed to said second modified cable, said network port connector being adapted to connect to said network port, and
d. providing bridging circuitry for electrically interconnecting an upstream end of said auxiliary conductor of said first modified cable with an upstream end of a corresponding auxiliary conductor of said second modified cable.

19. The method of claim 18 wherein said downstream device electrical connector of said first modified cable is further defined as being one of a plug and mating jack pair.

20. The method of claim 18 wherein said network port connector of said second modified cable is further defined as being one of a plug and mating jack pair.

21. The method of claim 18 wherein said bridging circuitry is further defined as comprising in combination;
a. a first connector component comprising one of a plug and jack mating pair, connected to said upstream end of said auxiliary wire of said first modified cable, and
b. a second connector component comprising a complementary one of said one of a plug and jack mating pair adapted to mate with said first connector component, said second connector component being connected to said upstream end of said second modified cable.

22. The method of claim 18 wherein said bridging circuitry is further defined as comprising;
a. a first, first-type connector component comprising one of a plug and jack mating pair connected to said upstream end of said auxiliary wire of said first modified cable,
b. a connector block comprising a plurality of parallel-wired second type connector components each comprising a complementary one of said plug and jack mating pair, each of said second type connector components adapted to mate with said first type connector component, and
c. a second, first-type connector component connected to an upstream end of said auxiliary wire of said second modified cable, said second first-type connector component being of the same type as said first connector and adapted to mate with another of a said plurality of said second-type connector block connectors.

23. The method of claim 18 wherein said bridging circuitry is further defined as including electronic signal interfacing circuitry which conforms to a particular network protocol.

24. The method of claim 23 wherein said network protocol is further defined as an Ethernet protocol.
